(19) United States
(12) Patent Application Publication
(10) Pub. No.: US 2023/0312345 A1
(43) Pub. Date: Oct. 5, 2023

(54) DINITROGEN PENTOXIDE GENERATING DEVICE AND METHOD FOR GENERATING DINITROGEN PENTOXIDE

(71) Applicant: TOHOKU UNIVERSITY, Sendai-shi, Miyagi (JP)

(72) Inventors: Toshiro KANEKO, Sendai-shi (JP); Keisuke TAKASHIMA, Sendai-shi (JP); Shota SASAKI, Sendai-shi (JP)

(73) Assignee: TOHOKU UNIVERSITY, Sendai-shi, Miyagi (JP)

(21) Appl. No.: 18/018,918

(22) PCT Filed: Jul. 28, 2021
(86) PCT No.: PCT/JP2021/027883

§ 371 Date: Jan. 31, 2023

(30) Foreign Application Priority Data
Aug. 7, 2020 (JP) 2020-134560

(51) Int. Cl. C01B 21/20; C01B 13/11

(52) U.S. Cl. CPC C01B 21/203; C01B 13/11

(57) ABSTRACT

A dinitrogen pentoxide generating device and a method for generating dinitrogen pentoxide. An NOx generating unit is able to use, as a raw material gas, a gas containing nitrogen and oxygen and produce a plasma to generate a nitrogen oxide. An ozone generating unit is able to use, as a raw material gas, the gas containing nitrogen and oxygen or a gas obtained after the plasma has been produced by the NOx generating unit and produce a plasma to generate ozone. A mixing unit is able to hold the nitrogen oxide generated by the NOx generating unit and the ozone generated by the ozone generating unit in the same space for a predetermined time to generate dinitrogen pentoxide.

### FIELD OF THE INVENTION

The present invention relates to a dinitrogen pentoxide generating device and a method for generating dinitrogen pentoxide.

### DESCRIPTION OF RELATED ART

Although dinitrogen pentoxide (N₂O₅) in gas phase is a substance which is difficult to store due to thermal decomposition and the like, since a highly reactive intermediate (NO₂) is temporarily generated when the dinitrogen pentoxide is dissolved in a liquid and thus a specific chemical reaction is induced to obtain effects such as sterilization, disinfection, cell activation and the like, the dinitrogen pentoxide is expected to be applied not only in chemical fields but also in environmental, agricultural and medical fields.

Conventional examples of a method for generating dinitrogen pentoxide include: a method (see, for example, Non-Patent Literature 1) for generating dinitrogen pentoxide by mixing concentrated sulfuric acid and concentrated nitric acid (pH<1) and dehydrating the mixture with diphosphorus pentoxide (P₄O₁₀); a method (see, for example, Non-Patent Literature 1) for generating dinitrogen pentoxide by dissolving a salt ([NO₂⁺·BF₄⁻], (NO₂·CF₃SO₃⁻)) at room temperature; and a method (see, for example, Non-Patent Literature 2) for generating dinitrogen pentoxide by mixing ozone gas and a high-concentration nitrogen dioxide gas.

### CITATION LIST

Non-Patent Literature 1: E. Wiberg, N. Wiberg and A. Holleman, “Inorganic Chemistry”, Berlin: Academic Press, 2001
Non-Patent Literature 2: C. H. Wu, E. D. Morris, and H. Niki, “The Reaction of Nitrogen Dioxide with Ozone”, J. Phys. Chem., 1973, 77, p. 2507

### SUMMARY OF THE INVENTION

However, disadvantageously, since in the method disclosed in Non-Patent Literature 1 and using concentrated sulfuric acid and concentrated nitric acid as raw materials, these raw materials are strong acids and a severe exothermic reaction occurs when the dinitrogen pentoxide is generated, the method is highly dangerous. Moreover, disadvantageously, since in the method which is disclosed in Non-Patent Literature 1 and in which the salt is dissolved at room temperature, the salt serving as the raw material is highly hygroscopic, for example, a high vacuum is required, with the result that it is extremely difficult to manufacture the salt serving as the raw material. Disadvantageously, since in the method disclosed in Non-Patent Literature 3, the high-concentration nitrogen dioxide serving as the raw material is toxic, it is very dangerous to handle it. Moreover, disadvantageously, when dinitrogen pentoxide is synthesized, the dinitrogen pentoxide is frozen in liquid nitrogen, is solidified and is separated, and explosive solid ozone is simultaneously generated, with the result that the method is highly dangerous.

The present invention is made in view of the problems described above, and an object of the present invention is to provide a dinitrogen pentoxide generating device and a method for generating dinitrogen pentoxide in which a highly safe raw material can be used and dinitrogen pentoxide can be relatively easily manufactured.

In order to achieve the object described above, a dinitrogen pentoxide generating device according to the present invention includes: an NOx generating unit that uses, as a raw material gas, a gas containing nitrogen and oxygen and produces a plasma to generate a nitrogen oxide (NOx); an ozone generating unit that uses, as a raw material gas, the gas containing nitrogen and oxygen or a gas obtained after the plasma has been produced by the NOx generating unit and produces a plasma to generate ozone; and a mixing unit that holds the nitrogen oxide generated by the NOx generating unit and the ozone generated by the ozone generating unit in the same space for a predetermined time to generate dinitrogen pentoxide.

A method for generating dinitrogen pentoxide according to the present invention includes: an NOx generation step of using, as a raw material gas, a gas containing nitrogen and oxygen and producing a plasma to generate a nitrogen oxide; an ozone generation step of using, as a raw material gas, the gas containing nitrogen and oxygen or a gas obtained after the plasma has been produced in the NOx generation step and producing a plasma to generate ozone; and a mixing step of holding the nitrogen oxide generated in the NOx generation step and the ozone generated in the ozone generation step in the same space for a predetermined time to generate dinitrogen pentoxide.

The method for generating dinitrogen pentoxide according to the present invention is preferably performed by the dinitrogen pentoxide generating device according to the present invention. In the dinitrogen pentoxide generating device and the method for generating dinitrogen pentoxide according to the present invention, as the raw material, a highly safe gas containing nitrogen and oxygen can be used. As the gas containing nitrogen and oxygen, for example, air can be used, and a plasma produced by atmospheric discharge can be utilized. The nitrogen oxide and the ozone generated with the plasma are held in the same space for the predetermined time, and thus the nitrogen oxide and the ozone are caused to react with each other, with the result that it is possible to manufacture dinitrogen pentoxide. As described above, in the dinitrogen pentoxide generating device and the method for generating dinitrogen pentoxide according to the present invention, the highly safe raw material and the plasma are utilized, and thus it is possible to relatively easily manufacture dinitrogen pentoxide.

In the dinitrogen pentoxide generating device and the method for generating dinitrogen pentoxide according to the present invention, when the gas containing nitrogen and oxygen is used as the raw material gas for generating the ozone, the nitrogen oxide and the ozone which are separately generated are collected in the same space and are held for the predetermined time. When a gas obtained after the nitrogen oxide has been generated by the plasma is used as the raw material gas for generating the ozone, the nitrogen oxide and the ozone are contained in the gas obtained after the generation of the ozone, and thus the gas obtained after the generation of the ozone is put into one space and is held for the predetermined time.

In the dinitrogen pentoxide generating device and the method for generating dinitrogen pentoxide according to the present invention, examples of the nitrogen oxide which is generated by the plasma using the gas containing nitrogen and oxygen as the raw material gas include NO, NO₂ and N₂O.

Preferably, in the dinitrogen pentoxide generating device according to the present invention, the NOx generating unit produces the plasma at a temperature equal to or greater than 200° C., the ozone generating unit produces the plasma at a temperature equal to or less than 50° C. and the mixing unit holds the nitrogen oxide and the ozone at a temperature equal to or less than 100° C. Preferably, in the method for generating dinitrogen pentoxide according to the present invention, in the NOx generation step, the plasma is produced at a temperature equal to or greater than 200° C., in the ozone generation step, the plasma is produced at a temperature equal to or less than 50° C. and in the mixing step, the nitrogen oxide and the ozone are held at a temperature equal to or less than 100° C. in this case, the plasma is produced at a temperature equal to or greater than 200° C., and thus it is possible to efficiently dissociate nitrogen in the raw material gas, with the result that the efficiency of generating the nitrogen oxide with the plasma can be increased. Moreover, the plasma is produced at a temperature equal to or less than 50′C, and thus the efficiency of generating the ozone with the plasma can be increased. In this way, it is also possible to increase the efficiency of generating dinitrogen pentoxide. The nitrogen oxide and the ozone are held at a temperature equal to or less than 100° C., and thus it is possible to further increase the efficiency of generating dinitrogen pentoxide.

Preferably, the dinitrogen pentoxide generating device according to the present invention includes a raw material gas generating unit that adjusts the humidity of the gas containing nitrogen and oxygen to 1×10¹⁵ cm⁻³ or less (about 40 ppm) to supply the gas containing nitrogen and oxygen to the NOx generating unit and the ozone generating unit or to the NOx generating unit. Preferably, the method for generating dinitrogen pentoxide according to the present invention includes a raw mated al gas generation step of adjusting the humidity of the gas containing nitrogen and oxygen to 1×10¹⁵ cm⁻³ or less (about 40 ppm) to supply the gas containing nitrogen and oxygen to the NOx generation step and the ozone generation step or to the NOx generation step. In this case, it is possible to manufacture dinitrogen pentoxide at high concentrations.

In the dinitrogen pentoxide generating device according to the present invention, the mixing unit may include a tube, introduce, from an opening of the tube on one end side, a gas containing the nitrogen oxide generated by the NOx generating unit and a gas containing the ozone generated by the ozone generating unit and discharge the resulting gas from and opening of the tube on the other end side after the predetermined time has elapsed. In the method for generating dinitrogen pentoxide according to the present invention, in the mixing step, a gas containing the nitrogen oxide generated by the NOx generation step and a gas containing the ozone generated by the ozone generation step may be introduced from an opening of the tube on one end side, and may be discharged from an opening of the tube on the other end side after the predetermined time has elapsed. In this case, the nitrogen oxide and the ozone can be caused to react with each other within the tube, and dinitrogen pentoxide generated by the reaction can be discharged from the opening of the tube on the other end side. The tube preferably has a length and a diameter that allow a predetermined time for a reaction which occurs while the nitrogen oxides and the ozone introduced from the opening on the one end side are passing through the interior of the tube.

Preferably, in the dinitrogen pentoxide generating device according to the present invention, the dinitrogen pentoxide generated by the mixing unit is discharged into a liquid. Preferably, in the method for generating dinitrogen pentoxide according to the present invention, the dinitrogen pentoxide generated in the mixing step is discharged into a liquid. In this case, a highly reactive intermediate (NO₂) is temporarily generated when the dinitrogen pentoxide is dissolved in the liquid, and thus a specific chemical reaction is induced, with the result that it is possible to generate, for example, sterilizing active species such as HOONO and HOONO₂ and plant growth-promoting active species such as NO₃⁻. In this way, the liquid into which the dinitrogen pentoxide is discharged can be utilized for sterilization, disinfection, cell activation and the like.

In the dinitrogen pentoxide generating device and the method for generating dinitrogen pentoxide according to the present invention, the predetermined time is preferably 0.5 to 600 seconds and particularly preferably 20 seconds or more. In this case, dinitrogen pentoxide can be manufactured efficiently and selectively in particular.

According to the present invention, it is possible to provide a dinitrogen pentoxide generating device and a method for generating dinitrogen pentoxide in which a highly safe raw material can be used and dinitrogen pentoxide can be relatively easily manufactured.

### BRIEF DESCRIPTION OF THE DRAWINGS

FIG. 1 is a block diagram showing a dinitrogen pentoxide generating device in an embodiment of the present invention.

FIGS. 2(a) and 2(b) are respectively front views showing an NOx generating unit and an ozone generating unit in the dinitrogen pentoxide generating device shown in FIG. 1.

FIG. 3 is a block diagram showing a variation of the dinitrogen pentoxide generating device in the embodiment of the present invention.

FIG. 4 is a graph showing the number densities (Densities) of active species contained in a gas manufactured by the dinitrogen pentoxide generating device shown in FIG. 1.

FIG. 5 is an IR spectrum of the gas manufactured by the dinitrogen pentoxide generating device shown in FIG. 1.

FIG. 6 is a graph showing a relationship between a time tᵣ and the number densities (Densities) of the active species when the length and the inside diameter of a tube in the dinitrogen pentoxide generating device shown in FIG. 1 are changed and the time tᵣ during which nitrogen oxides and ozone react with each other is changed.

### DETAILED DESCRIPTION OF THE INVENTION

An embodiment of the present invention will be described below with reference to drawings.

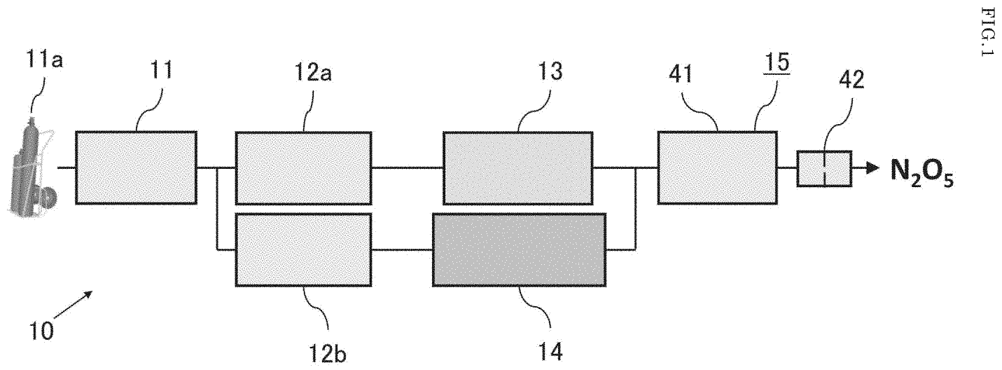

FIGS. 1 to 6 show a dinitrogen pentoxide generating device and a method for generating dinitrogen pentoxide in the embodiment of the present invention.

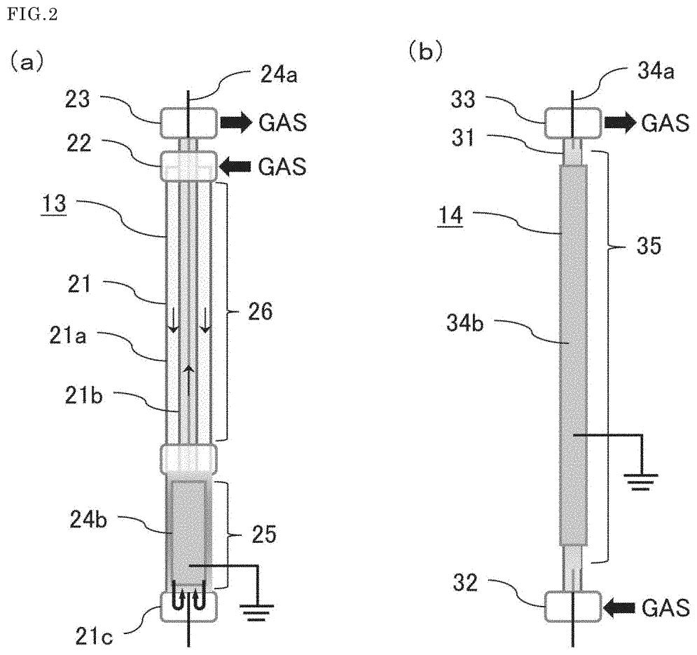

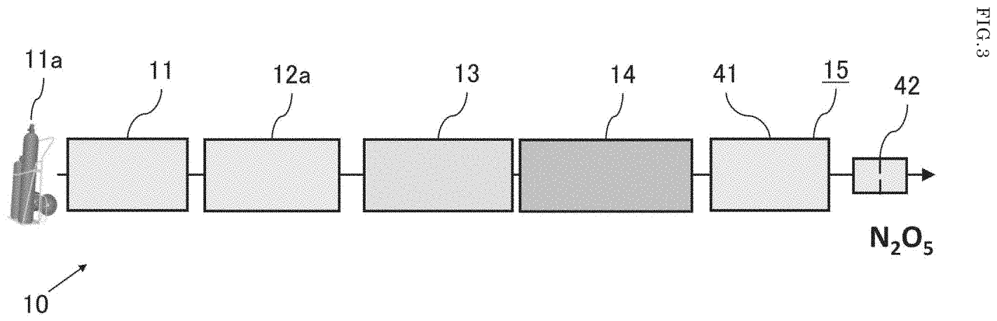

As shown in FIGS. 1 and 2 the dinitrogen pentoxide generating device 10 includes a raw material gas generating unit 11, a pair of flow rate control units 12a and 12b, an NOx generating unit 13, an ozone generating unit 14 and a mixing unit 15.

As shown in FIG. 1, the raw material gas generating unit 11 is configured to be able to introduce a gas containing nitrogen and oxygen, dehydrate the gas and adjust the humidity thereof. The raw material gas generating unit 11 is configured to be able to supply, as a raw material gas, the gas whose humidity has been adjusted to the NOx generating unit 13 and the ozone generating unit 14 through the flow rate control units 12a and 12b. In a specific example shown in FIG. 1, the raw material gas generating unit 11 adjusts the humidity of the introduced gas to 1×10¹⁵ cm⁻³ (about 40 ppm) or less. The raw material gas generating unit 11 is connected to a cylinder 11a in which the gas containing nitrogen and oxygen is stored, and introduces the gas from the cylinder 11a. Although the gas stored in the cylinder 11a is made of air, the gas may be a gas other than air as long as the gas contains nitrogen and oxygen. When air is used, the surrounding air may be collected and used without use of the cylinder 11a.

The flow rate control unit 12a on one side is connected to the raw material gas generating unit 11 and the NOx generating unit 13, and the flow rate control unit 12b on the other side is connected to the raw material gas generating unit 11 and the ozone generating unit 14. The flow rate control units 12a and 12b are configured to be able to introduce the raw material gas whose humidity has been adjusted by the raw material gas generating unit 11, adjust the flow rate and the velocity of flow thereof and supply the raw material gas to the NOx generating unit 13 and the ozone generating unit 14, respectively.

As shown in NG. 2(a), the NOx generating unit 13 includes a reaction container 21, a gas supply unit 22, a gas discharge unit 23, a pair of electrodes 24a and 24b and a power supply unit (not shown). The reaction container 21 includes: an elongated cylindrical outer tube 21a; an elongated cylindrical inner tube 21b which is spaced with respect to the outer tube 21a and is inserted inside the outer tube 21a; and a cap 21c which blocks the opening of the outer tube 21a on one end side. Each of the outer tube 21a and the inner tube 21b is made of an insulator. The inner tube 21b is spaced with respect to the cap 21c on the one end side of the reaction container 21. In this way, on the one end side of the reaction container 21, a space inside the inner tube 21b communicates with a space between the outer tube 21a and the inner tube 21b.

The gas supply unit 22 is connected to the flow rate control unit 12a on the one side, and is provided to block the opening of the outer tube 21a on the other end side of the reaction container 21. The gas supply unit 22 is configured to introduce the raw material gas supplied from the flow rate control unit 12a on the one side into the space between the outer tube 21a and the inner tube 21b. The gas discharge unit 23 is connected to the mixing unit 15, and is provided to block the opening of the inner tube 21b on the other end side of the reaction container 21. The gas discharge unit 23 is configured to be able to discharge the gas in the space inside the inner tube 21b and supply the gas to the mixing unit 15. In this way, in the NOx generating unit 13, the raw material gas introduced by the gas supply unit 22 into the space between the outer tube 21a and the inner tube 21b flows from the other end side to the one end side of the reaction container 21 within the space, enters the inside of the inner tube 21b on the one end side of the reaction container 21, further flows from the one end side to the other end side of the reaction container 21 inside the inner tube 21b and discharges from the gas discharge unit 23.

The electrode 24a on one side is inserted inside the inner tube 21b, and is arranged to extend from the one end side to the other end side of the reaction container 21 along the length direction of the inner tube 21b. The electrode 24b on the other side is formed with a stainless steel tube or the like, and is tubular. The electrode 24b on the other side is attached to one end portion of the reaction container 21 opposite the electrode 24a on the one side over a predetermined range (hereinafter referred to as a “plasma generating unit 25”) in the length direction of the reaction container 21 inside the outer tube 21a. The electrode 24b on the other side is grounded. The power supply unit is connected to the electrode 24a on the one side, and can apply a voltage between the electrodes 24a and 24b. In a specific example shown in FIG. 2(a), the power supply unit is configured to use a power of SOW at the maximum to apply the voltage between the electrodes 24a and 24b. Although the power supply unit is an alternating-current power supply, the power supply unit may be a direct-current power supply or a pulse power supply.

The NOx generating unit 13 uses the power supply unit to apply the voltage between the electrodes 24a and 24b in a state where the raw material gas is supplied from the flow rate control unit 12a on the one side through the gas supply unit 22 into the reaction container 21, and thus a plasma can be produced by the plasma generating unit 25. Here, the power to be applied is adjusted to produce the plasma at a temperature equal to or greater than 200′C, and thus nitrogen oxides such as NO, NO₂ and N₂O can be generated. In a range (hereinafter referred to as a “heat exchange unit 26”) from the other end side of the reaction container 21 to the plasma generating unit, the NOx generating unit 13 exchanges heat between a gas which is obtained after the production of the plasma and flows inside the inner tube 21b from the plasma generating unit 25 toward the gas discharge unit 23 and the raw material gas which flows in the space between the outer tube 21a and the inner tube 21b toward the plasma generating unit 25, and thereby can heat the raw material gas and cool the gas obtained after the production of the plasma. In this way, the temperature of the plasma generating unit 25 is maximized, and the temperature of the gas discharged from the gas discharge unit 23 is minimized.

As shown in FIG. 2(b), the ozone generating unit 14 includes a reaction container 31, a gas supply unit 32, a gas discharge unit 33, a pair of electrodes 34a and 34b and a power supply unit (not shown). The reaction container 31 is made of an insulator and is in an elongated cylindrical shape. The gas supply unit 32 is connected to the flow rate control unit 12b on the other side, and is provided to block the opening of the reaction container 31 on one end side. The gas supply unit 32 is configured to introduce the raw material gas supplied from the flow rate control unit 12b on the other side into the reaction container 31. The gas discharge unit 33 is connected to the mixing unit 15, and is provided to block the opening of the reaction container 31 on the other end side. The gas discharge unit 33 is configured to be able to discharge the gas in the space inside the reaction container 31 and supply the gas to the mixing unit 15.

The electrode 34a on one side is inserted into the reaction container 31, and is arranged to extend from the one end side to the other end side of the reaction container 31 along the length direction of the reaction container 31. The electrode 34b on the other side is formed with copper foil or the like, and is in the shape of a thin sheet. The electrode 34b on the other side is attached opposite the electrode 34a on the one side over a range (hereinafter referred to as a “plasma generating unit 35”) from one end portion to the other end portion of the reaction container 31 so as to be wrapped one revolution around the outer surface of the reaction container 31. The electrode 34b on the other side is grounded. The power supply unit is connected to the electrode 34a on the one side, and can apply a voltage between the electrodes 34a and 34b. In a specific example shown in FIG. 2(b), the power supply unit is configured to use a minimum power of about 3W to apply the voltage between the electrodes 34a and 34b. Although the power supply unit is an alternating-current power supply, the power supply unit may be a direct-current power supply or a pulse power supply.

The ozone generating unit 14 uses the power supply unit to apply the voltage between the electrodes 34a and 34b in a state where the raw material gas is supplied from the flow rate control unit 12b on the other side through the gas supply unit 32 into the reaction container 31, and thus a plasma can be produced by the plasma generating unit 35. Here, the power to be applied is adjusted to produce the plasma at a temperature equal to or less than 50° C., and thus ozone can be generated.

As shown in FIG. 1, the mixing unit 15 includes an elongated tube 41 and an orifice 42. The tube 41 is configured such that an opening on one end side is connected to the gas discharge unit 23 of the NOx generating unit 13 and to the gas discharge unit 33 of the ozone generating unit 14 and the gas containing the nitrogen oxides generated by the NOx generating unit 13 and the gas containing the ozone generated by the ozone generating unit 14 can be introduced thereinto and discharged from an opening on the other end side. The tube 41 has a, length and an inside diameter that allow time for a reaction which occurs while the nitrogen oxides and the ozone introduced are passing through the interior of the tube 41 to generate dinitrogen pentoxide. The orifice 42 is attached to the opening of the tube 41 on the other end side. The mixing unit 15 does not need to use the orifice 42.

The mixing unit 15 can discharge, from the orifice 42, the dinitrogen pentoxide generated within the tube 41. The mixing unit 15 is provided to be able to discharge the generated dinitrogen pentoxide into a liquid. In the specific example shown in FIG. 1, the tube 41 has a length of 5 to 50 m and an inside diameter of 4 to 10 mm that allow a time of 10 to 100 seconds during which the di nitrogen pentoxide is generated. The tube 41 is configured such that the nitrogen oxides and the ozone pass through the interior of the tube 41 at a temperature equal to or less than 100° C. The mixing unit 15 preferably allows time for generating the dinitrogen pentoxide, and may allow the time by increasing the pressure of the gas containing the nitrogen oxides and the gas containing the ozone or cooling the gasses.

A method for generating dinitrogen pentoxide in the embodiment of the present invention can be preferably performed by the dinitrogen pentoxide generating device 10. In the method for generating dinitrogen pentoxide in the embodiment of the present invention, a gas containing nitrogen and oxygen is used as a raw material gas, a plasma is produced by the NOx generating unit 13 to generate nitrogen oxides, a plasma is produced by the ozone generating unit 14 to generate ozone and the nitrogen oxides and the ozone generated are caused to react with each other within the tube 41 of the mixing unit 15 for a predetermined time, with the result that dinitrogen pentoxide can be generated.

In the dinitrogen pentoxide generating device 10 and the method for generating dinitrogen pentoxide in the embodiment of the present invention, as the raw material, a highly safe gas such as air containing nitrogen and oxygen can be used. The nitrogen oxides and the ozone generated with the plasma are held in the same space within the tube 41 for the predetermined time, and thus the nitrogen oxides and the ozone are caused to sufficiently react with each other, with the result that it is possible to manufacture dinitrogen pentoxide. As described above, in the dinitrogen pentoxide generating device 10 and the method for generating dinitrogen pentoxide in the embodiment of the present invention, the highly safe raw material and the plasma are utilized, and thus it is possible to relatively easily manufacture dinitrogen pentoxide.

In the dinitrogen pentoxide generating device 10 and the method for generating dinitrogen pentoxide in the embodiment of the present invention, the plasma is produced by the NOx generating unit 13 at a temperature equal to or greater than 200° C., and thus it is possible to efficiently dissociate nitrogen in the raw material gas, with the result that the efficiency of generating the nitrogen oxides with the plasma can be increased. The plasma is produced by the ozone generating unit 14 at a temperature equal to or less than 50° C., and thus the efficiency of generating the ozone with the plasma can be increased. While the power to be applied is kept constant, the length of the electrode 34b on the other side in the ozone generating unit 14 is increased to reduce a power density, and thus it is possible to suppress an increase in the temperature of the plasma generating unit 35, with the result that the efficiency of generating the ozone can be increased. By the heat exchange unit 26 of the NOx generating unit 13, the temperature of the plasma generating unit 25 in the NOx generating unit 13 can be maximized, and the temperature of the gas discharged from the gas discharge unit 23 can be minimized, with the result that the efficiency of generating the nitrogen oxides can be further increased. In this way, it is possible to increase the efficiency of generating dinitrogen pentoxide.

In the dinitrogen pentoxide generating device 10 and the method for generating dinitrogen pentoxide in the embodiment of the present invention, the humidity of the raw material gas is adjusted by the raw material gas generating unit 11 to 1×10¹⁵ cm⁻³ (about 40 ppm) or less, and thus it is possible to manufacture dinitrogen pentoxide at high concentrations.

In the dinitrogen pentoxide generating device 10 and the method for generating dinitrogen pentoxide in the embodiment of the present invention, the temperature of the gas obtained after the production of the plasma can be lowered by the heat exchange unit 26 of the NOx generating unit 13, and thus it is possible to suppress an increase in the temperature of the gas supply unit 22 and the gas discharge unit 23 in the NOx generating unit 13 and an increase in the temperature of the gas supply unit 32 in the ozone generating unit 14. Since the temperature at which the plasma is produced by the ozone generating unit 14 is set equal to or less than 50° C., it is possible to suppress an increase in the temperature of the gas discharge unit 33 in the ozone generating unit 14. In this way, it is possible to enhance the durability of the gas supply unit 22 and the gas discharge unit 23 in the NOx generating unit 13 and the gas supply unit 32 and the gas discharge unit 33 in the ozone generating unit 14. In particular, the temperatures of these units are maintained at a temperature equal to or less than 150° C., and thus it is possible to dramatically enhance the durability. Since the temperatures of the gas in the gas discharge unit 23 of the NOx generating unit 13 and the gas in the gas discharge unit 33 of the ozone generating unit 14 are low, the temperature of the gas in the mixing unit 15 can be lowered, with the result that it is possible to efficiently generate dinitrogen pentoxide.

In the dinitrogen pentoxide generating device 10 and the method for generating dinitrogen pentoxide in the embodiment of the present invention, the dinitrogen pentoxide generated by the mixing unit 15 is discharged into a liquid, and thus a highly reactive intermediate (NO₂) is temporarily generated when the dinitrogen pentoxide is dissolved in the liquid to induce a specific chemical reaction, with the result that it is possible to generate, for example, sterilizing active species such as HOONO and HOONO₂ and plant growth-promoting active species such as NO₃⁻. In this way, the liquid into which the dinitrogen pentoxide is discharged can be utilized for sterilization, disinfection, cell activation and the like.

As shown in FIG. 3, in the dinitrogen pentoxide generating device 10, the ozone generating unit 14 may be arranged between the NOx generating unit 13 and the mixing unit 15. Specifically, the gas supply unit 32 of the ozone generating unit 14 may be provided to be connected to the gas discharge unit 23 of the NOx generating unit 13, and the ozone generating unit 14 may be provided to be able to use, as the raw material gas, a gas obtained after a plasma has been produced by the NOx generating unit 13 and produce a plasma to generate ozone. In this case, since the ozone and the nitrogen oxides generated by the NOx generating unit 13 are contained in the gas obtained after the generation of the ozone, the gas obtained after the generation of the ozone is put into the tube 41 and is held for a predetermined time, and thus it is possible to generate di nitrogen pentoxide. Since only one flow rate control unit 12a is used, the manufacturing cost and the operating cost of the device can be reduced.

### Example 1

The dinitrogen pentoxide generating device 10 shown in FIG. 1 was used, and thus an experiment was performed on the manufacturing of dinitrogen pentoxide. In the experiment, air was used as a raw material gas, the flow rate control unit 12a on the one side was used to supply the raw material gas to the NOx generating unit 13 at a flow rate of 1 slm, and the flow rate control unit 12b on the other side was used to supply the raw material gas to the ozone generating unit 14 at a flow rate of 1 still. The inside diameter and the length of the tube 41 in the mixing unit 15 were set to 10 mm and 10 m, respectively. In this way, the time during which a gas containing nitrogen oxides and a gas containing ozone passed through the interior of the tube 41, that is, the time during which the nitrogen oxides and the ozone reacted with each other was 24 seconds.

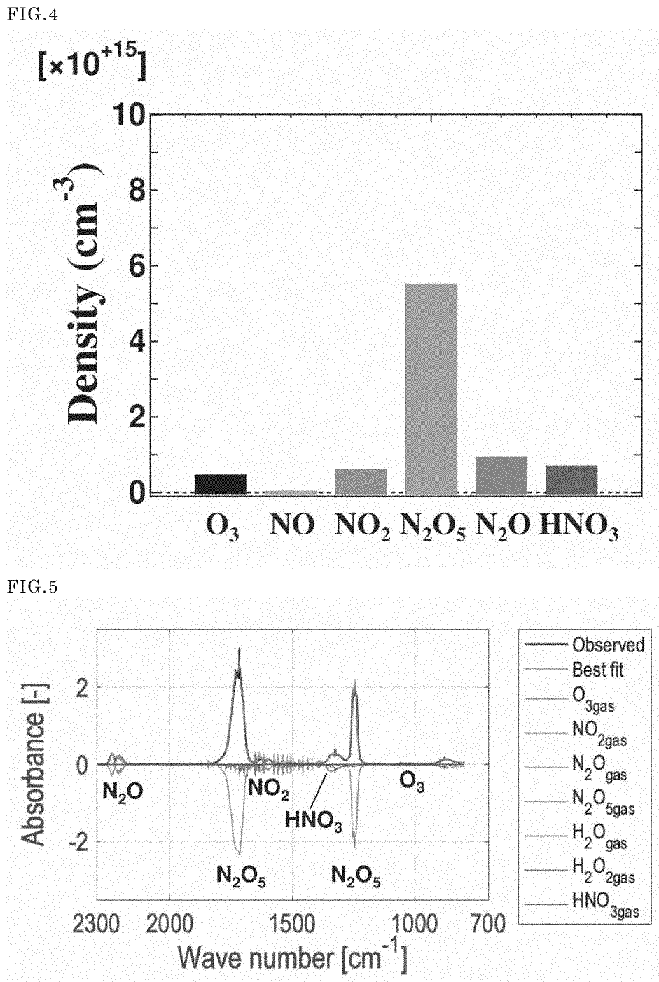

For a gas discharged from the orifice 42, an infrared absorption spectrum OR spectrum) was determined with a Fourier transform infrared spectroscopy (FT-HO device by infrared spectroscopy, and the number densities (Densities) of active species contained in the gas were determined. The number densities of the active species and the IR spectrum which were determined were shown in FIGS. 4 and 5, respectively. As shown in FIGS. 4 and 5, it was confirmed that in the gas discharged from the mixing unit 15, the amount of dinitrogen pentoxide (N₂O₅) was larger than the amounts of nitrogen oxides (NO, NO₂, N₂O and HNO₃) generated by the NOx generating unit 13 and ozone (O₃) generated by the ozone generating unit 14. This is considered to be because the nitrogen oxides and the ozone sufficiently react with each other within the tube 41 of the mixing unit 15 to generate dinitrogen pentoxide.

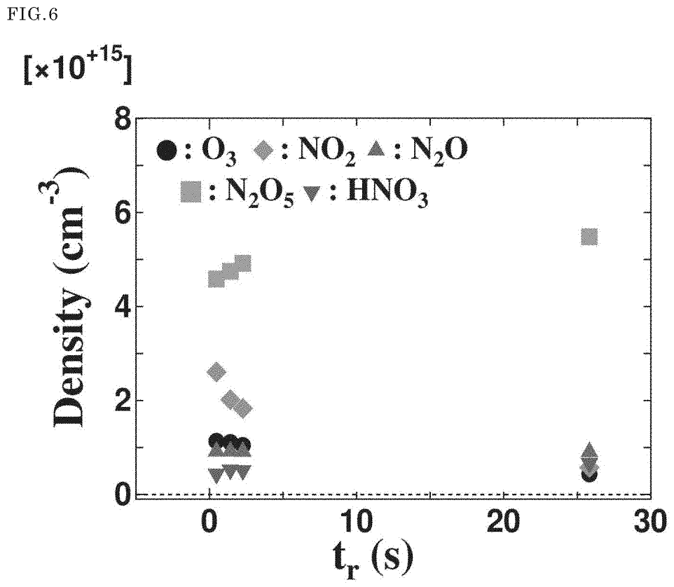

Then, the length and the inside diameter of the tube 41 in the mixing unit 15 were changed, and while a time during which the gases passed through the tube 41, that is, a time tᵣ during which the nitrogen oxides and the ozone reacted with each other was being changed, the number densities (Densities) of the active species contained in the gas discharged from the orifice 42 were determined with the Fourier transform infrared spectroscopy device. The results thereof are shown in FIG. 6. It was confirmed that as shown in FIG. 6, the amount of dinitrogen pentoxide (N₂O₅) continued to be increased with the reaction time tᵣ and was saturated after 20 seconds or more. It was also confirmed that the ozone (O₃) and NO₂ were rapidly reduced until the reaction time tᵣ reached about 30 seconds. It was also confirmed that NO was not increased or decreased even when the reaction time tᵣ was reached so as to almost remain the same. It was also confirmed that the amount of HNO₃ was slightly increased until the reaction time tᵣ reached about 30 seconds.

It is said from the results shown in FIG. 6 that the mixing unit 15 is formed such that the reaction time tᵣ is 20 seconds or more, and thus it is possible to efficiently manufacture dinitrogen pentoxide. It is considered that N₂O mainly reacts with the ozone to generate dinitrogen pentoxide.

### REFERENCE SIGNS LIST

10: Dinitrogen pentoxide generating device
11: Raw material gas generating unit
11a: Cylinder
12a. Pb: Flow rate control unit
13: NOx generating unit
21: Reaction container
21a: Outer tube
21b: Inner tube
21c: Cap
22: Gas supply unit
23: Gas discharge unit
24a, 24b: Electrode
25: Plasma generating unit
26: Heat exchange unit
14: Ozone generating unit
31: Reaction container
32: Gas supply unit
33: Gas discharge unit
34a, 34b: Electrode
35: Plasma generating unit
15: Mixing unit
41: Tube
42: Orifice

1. A dinitrogen pentoxide generating device comprising:
an NOx generating unit that uses, as a raw material gas, a gas containing nitrogen and oxygen and produces a plasma to generate a nitrogen oxide;
an ozone generating unit that uses, as a raw material gas, the gas containing nitrogen and oxygen or a gas obtained after the plasma has been produced by the NOx generating unit and produces a plasma to generate ozone; and
a mixing unit that holds the nitrogen oxide generated by the NOx generating unit and the ozone generated by the ozone generating unit in a same space for a predetermined time to generate dinitrogen pentoxide.

2. The dinitrogen pentoxide generating device according to claim 1,
wherein the NOx generating unit produces the plasma at a temperature equal to or greater than 200° C.,
the ozone generating unit produces the plasma at a temperature equal to or less than 50° C. and
the mixing unit holds the nitrogen oxide and the ozone at a temperature equal to or less than 100° C.

3. The dinitrogen pentoxide generating device according to claim 1, comprising:
a raw material gas generating unit that adjusts a humidity of the gas containing nitrogen and oxygen to 1×10¹⁵ cm⁻³ or less to supply the gas containing nitrogen and oxygen to the NOx generating unit and the ozone generating unit or to the NOx generating unit.

4. The dinitrogen pentoxide generating device according to claim 1,
wherein the mixing unit includes a tube, introduces, from an opening of the tube on one end side, a gas containing the nitrogen oxide generated by the NOx generating unit and a gas containing the ozone generated by the ozone generating unit and discharges the resulting gas from an opening of the tube on the other end side after the predetermined time has elapsed.

5. The dinitrogen pentoxide generating device according to claim 1,
wherein the dinitrogen pentoxide generated by the mixing unit is discharged into a liquid.

6. The dinitrogen pentoxide generating device according to claim 1,
wherein the predetermined time is equal to or greater than 20 seconds.

7. A method for generating dinitrogen pentoxide, the method comprising:
an NOx generation step of using, as a raw material gas, a gas containing nitrogen and oxygen and producing a plasma to generate a nitrogen oxide;
an ozone generation step of using, as a raw material gas, the gas containing nitrogen and oxygen or a gas obtained after the plasma has been produced in the NOx generation step and producing a plasma to generate ozone; and
a mixing step of holding the nitrogen oxide generated in the NOx generation step and the ozone generated in the ozone generation step in a same space for a predetermined time to generate dinitrogen pentoxide.
